(19) United States
(12) Patent Application Publication
(10) Pub. No.: US 2008/0172617 A1
(43) Pub. Date: Jul. 17, 2008

(54) INFORMATION PROCESSING APPARATUS, DISPLAY METHOD AND RECORDING MEDIUM

(75) Inventors: Tomonori Takeda, Kawasaki (JP); Tetsuo Yamaguchi, Kawasaki (JP); Daijoh Nakayama, Kawasaki (JP); Takeshi Yoshida, Kawasaki (JP); Shigeaki Oura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/965,218

(22) Filed: Dec. 27, 2007

(30) Foreign Application Priority Data
Jan. 15, 2007 (JP) JP2007-005452

(51) Int. Cl. G06F 3/00

(52) U.S. Cl. 715/733

(57) ABSTRACT

An information processing apparatus and method configured to display content in a content display screen area, which is at least one of a plurality of screen areas, displayed. The information processing apparatus includes an event detector configured to detect generation of a predetermined event concerning a content, a notifying unit configured to notify a user of the information processing apparatus of the detection of the predetermined event upon detecting the predetermined event, a work concentration state detector configured to determine whether the user is in a work concentration state, and an inhibiting unit configured to inhibit the notifying unit from notifying the user of the detection of the predetermined event upon determining the work concentration state of the user.

This application is related to and claims the benefit of priority from Japanese patent application No. 2007-5452 filed on Jan. 15, 2007, in the Japan Patent Office, and incorporated by reference herein.

### BACKGROUND

1. Field

The present invention relates to a technique for displaying content in one of a plurality of screen areas displayed in a display unit of an information processing apparatus.

2. Description of the Related Art

Personal computers (PCs) that can receive and display television broadcast programs by installing or connecting television tuners to the PCs are widely becoming available on the market.

In such PCs, as in dedicated recording/playback apparatuses, such as digital versatile disk (DVD) recorders or hard disk drive (HDD) recorders, recording received television programs, editing them if necessary, and then storing the edited programs in recording media, such as DVDs, are commonly performed.

Generally, information processing apparatuses, such as PCs, can execute various types of processing by the use of hardware or software. Accordingly, such apparatuses have general-purpose functions for performing such processing, and can also perform a plurality of types of processing in parallel. In such information processing apparatuses, the function of receiving and displaying television programs is one type of such processing. A user may display a plurality of windows on a display, and while displaying a received television program in one of the windows, the user can start a browser and connect to the Internet to search for information or start a word-processor to form a document in another window.

Accordingly, using information processing apparatuses, such as PCs, that can perform a plurality of types of processing in parallel, the user may receive and display television broadcasts, not only for viewing and recording the broadcast programs, but also for leisurely watching them while doing another work. That is, the information processing apparatuses may be used for a purpose and in a manner different from genuine recorders.

Although leisurely watching broadcast programs while doing another work is a subsidiary activity in contrast to the main work, such as Internet search or document formation, it is a new usage model, which cannot be implemented using genuine recording/playback apparatuses, such as DVD recorders.

According to this usage model, the user can concentrate on the main work while a television program not of interest to the user or a commercial is being shown, and the user may interrupt the main work and start watching the television program when a television program of interest is displayed or when a television program is restarted after a commercial has been finished.

If, however, the user concentrates on the main work, the user may not realize that there has been a change in television programs (e.g., that a commercial has been finished) and miss a television program that the user wishes to watch.

Typically, various items of information, such as hobby information, that are obtained via the Internet maybe displayed on a display, together with a television program. If, in that television program, a volume reaching a predetermined threshold (e.g., in the case of a great cheer) is detected as an event, the program is displayed such that the size of the program is enlarged to the full screen of the display. This can allow the user to recognize that the event has been generated.

If the user does not really want to miss the television program, which is very important, the user can reserve the program by the use of, for example, a reserve-recording function or an alarm, such as an alarm clock/watch. Generally, however, most leisurely watched television programs, such as news or weather forecasts, are programs that the user does not want to be burdened with the trouble of reserve-record or setting an alarm, but are programs to which the user simply wants to pay attention when the same are broadcast.

In the above-described related technique, if a predetermined event in a television program is detected, the television program is displayed such that the size of the television program is enlarged to the full screen, which may disturb the main work on which the user is concentrating.

Accordingly, in view of the above, it is an object of the present invention to prevent a user of an information processing apparatus from missing content that the user wishes to watch without interrupting the main work on which the user is concentrating.

### SUMMARY

The disclosed information processing apparatus including a display unit to display content in a content display screen area, which is at least one of a plurality of screen areas, displayed in the display unit. The information processing apparatus includes an event detector configured to detect generation of a predetermined event concerning content, a notifying unit configured to notify a user of the information processing apparatus of the detection of the predetermined event upon detecting the predetermined event by the event detector, a work concentration state detector configured to determine whether the user is in a work concentration state, and an inhibiting unit configured to inhibit the notifying unit from notifying the user of the detection of the predetermined event upon determining the work concentration state of the user.

The work concentration state detector may determine whether the user is in the work concentration state based on screen area processing state information concerning processing states of the plurality of screen areas. The work concentration state detector may determine whether the user is in the work concentration state based on apparatus processing state information concerning processing executed in the information processing apparatus.

The disclosed display method provides content in a content display screen area, which is at least one of a plurality of screen areas, displayed in a display unit of an information processing apparatus. The display method includes detecting generation of a predetermined event concerning the a content, notifying a user of the information processing apparatus of the detection of the predetermined event upon detecting the predetermined event, determining whether the user is in a work concentration state, and inhibiting the user from being notified of the detection of the predetermined event upon determining the work concentration state of the user.

There is provided a display program for allowing a computer to execute operations including displaying content in a content display screen area, which is at least one of a plurality of screen areas, displayed in a display unit of an information processing apparatus. The display program includes detecting generation of a predetermined event concerning a content, notifying a user of the information processing apparatus of the detection of the predetermined event upon detecting the predetermined event, determining whether the user is in a work concentration state, and inhibiting the user from being notified of the detection of the predetermined event upon determining the work concentration state of the user.

According to the disclosed apparatus and method, at least one of the following advantages can be achieved. If it is determined that the user is in the work concentration state, the user can be inhibited from being notified of the generation of an event. This can improve the work efficiency without disturbing work on which the user is concentrating. It can be determined whether the user is in the work concentration state on the basis of the screen area processing state information indicating the processing states of the plurality of screen areas in the information processing apparatus or the apparatus processing state information concerning processing executed in the information processing apparatus. It is thus possible to easily detect the work concentration state that matches the actual working state in the information processing apparatus, thereby enhancing the usability.

If the user is notified of the generation of an event by enlarging the size of the content display screen area on the display the size of the content display screen area is inhibited from being enlarged, or the size of the content display screen area is reduced. With this configuration, the work efficiency can be enhanced without disturbing the work on which the user is concentrating by the enlarged content display screen area.

The volume of sound accompanying the display of a television program is suppressed. With this configuration, the work efficiency can be enhanced without disturbing the work on which the user is concentrating by sound.

The content display screen area is changed to the non-display state, and also, the content is recorded. With this configuration, the work efficiency can be enhanced without interrupting the work on which the user is concentrating, and also, the user does not have to miss the content since the recorded content can be displayed later, thereby enhancing the usability.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram schematically illustrating the functional configuration of information processing;

FIG. 2 is a block diagram schematically illustrating an example of the hardware configuration of an information processing apparatus;

FIG. 3 illustrates an example of a display screen of a display of an information processing apparatus;

FIG. 4 is a flowchart illustrating an example of a method for acquiring apparatus processing state information by an apparatus processing state information acquisition unit of an information processing apparatus;

FIG. 5 is a flowchart illustrating an example of a method for acquiring state information acquired by a state information acquisition unit of an information processing apparatus;

FIGS. 6 through 10 illustrate examples in which preference evaluation values are calculated by a preference evaluation value calculator of an information processing;

FIG. 11 illustrates an example in which preference values are calculated in an information processing apparatus;

FIG. 12 is a flowchart illustrating a method for obtaining preference information by analyzing a user's preferences when displaying a television program in an information processing apparatus;

FIG. 13 is a block diagram schematically illustrating the functional configuration for implementing a notifying function of an information processing apparatus; and

FIG. 14 is a flowchart illustrating a method for notifying a user of the detection of an event when displaying a television program in an information processing apparatus.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

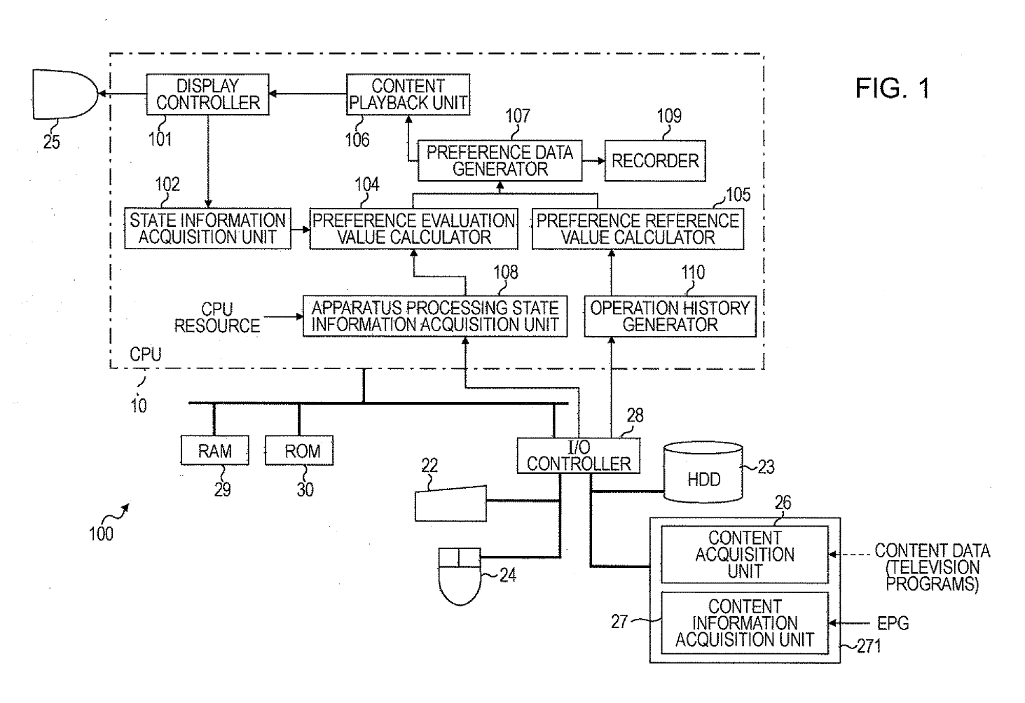

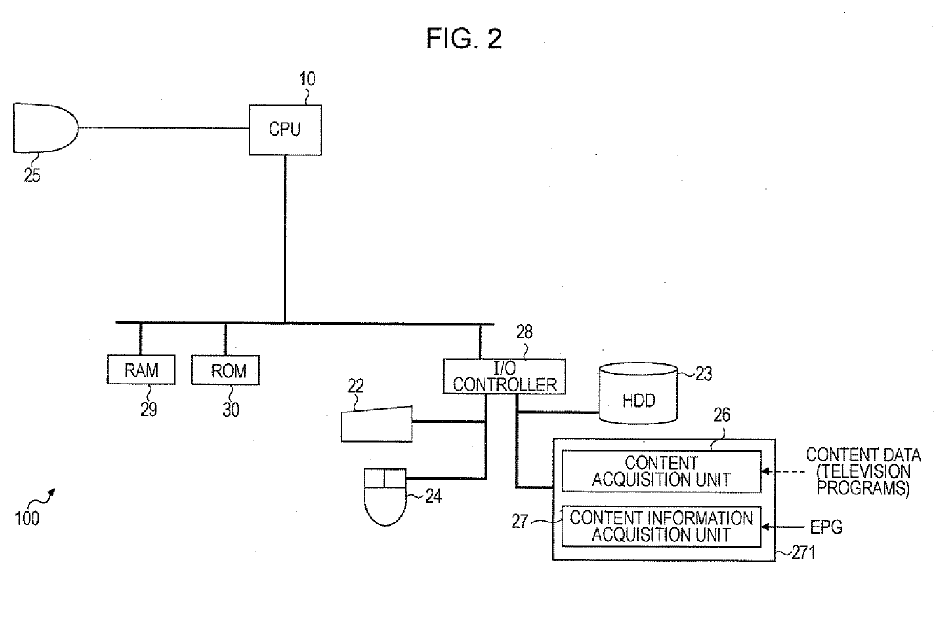

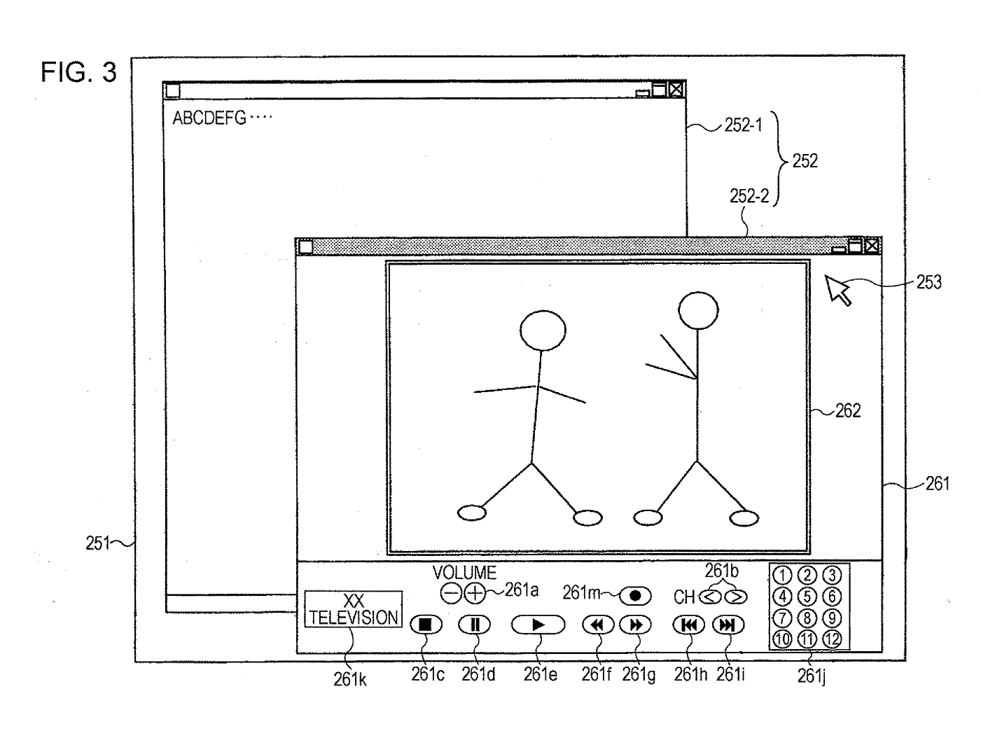

FIG. 1 is a schematic view illustrating the functional configuration of an information processing apparatus 100. FIG. 2 is a schematic view illustrating an example of the hardware configuration of the information processing apparatus 100. FIG. 3 illustrates an example of a display screen 251 of a display 25 of the information processing apparatus 100 (FIG. 1).

The information processing apparatus 100, which serves as a preference-data generating apparatus or a content display apparatus, may include, as shown in FIG. 2, a central processing unit (CPU) 10, an input/output (I/O) controller 28, a keyboard 22, a hard disk drive (HDD) 23, a mouse 24, a display 25, a television tuner 271, a random access memory (RAM) 29, and a read only memory (ROM) 30. The information processing apparatus 100 may be configured as a computer system that can execute a plurality of types of processing in parallel. While the information processing apparatus is described as being configured as a computer system, the present invention is not limited to any particular computer, and may be implemented on a specialized device, a desktop or laptop system, or any other similar device enabled to execute parallel processes.

The display 25 is enabled to display various items of information and content under the control of a display controller 101. The display 25 may be a cathode ray tube (CRT), a liquid crystal display (LCD), etc.

The information processing apparatus 100 may include a multi-window function, as shown in FIG. 3. Using the multi-window function, the information processing apparatus 100 can display a plurality of (two in the example shown in FIG. 3) windows (screen areas) 252 on a display screen 251 of the display 25, and can independently execute different types of processing in the plurality of windows 252. The information processing apparatus 100 can also perform input operations or selection operations in the plurality of windows 252 by the use via an input unit, such as the keyboard 22 or the mouse 24, which is discussed in detail below.

The multi-window functions include functions substantially integrated with an operating system (OS), such as Microsoft Windows®, and functions separated from an OS, such as X windows system used in a UNIX® OS.

Using the information processing apparatus 100, content, such as moving pictures, etc., can be displayed (played back) in at least one of the plurality of windows 252 displayed in the display screen 251.

In the example shown in FIG. 3, two windows 252-1 and 252-2 are displayed in the display screen 251. For example, while a word-processing (program) is being executed in the window 252-1, a television program display program is being executed in the window 252-2 (content display screen area). Although FIG. 3 is described using a word processing program being executed while a television program, the present invention is not limited thereto. For example, various types of program(s), operation(s), or task(s) may be executed while viewing or parallel to a television program or other type of images.

Hereinafter, to specify any one of the windows 252, reference numeral 252 is used, and to specify a special window, reference numerals 252-1 and 252-2 are used.

In the example shown in FIG. 3, between the two windows 252-1 and 252-2 displayed in the display screen 251, the window 252-2 is in the active state (active window), and the windows 252-1 and 252-2 are at least partially overlapped with each other, the window 252-2 concealing part of the window 252-1.

The information processing apparatus 100 can execute a television program display program that allows the display of television programs (video and moving pictures), and as a result, a television program is displayed in the window 252-2. Hereinafter, displaying a television program in the window 252-2 as a result of executing the television program display program may be referred to as “executing the television program display program in the window 252-2.”

The window 252-2 in which the television program display program is being executed may include, as shown in FIG. 3, an operation area 261 and a television program display area 262. In the television program display area 262, a television program is displayed, and more specifically, a television program (content) received by the television tuner 271 (including a content acquisition unit 26 and a content information acquisition unit 27), which is discussed in detail below, is displayed. For example, moving pictures may be displayed in the display area 262.

In this case, content is moving pictures of, for example, movies and television programs, which are broadcast or distributed via broadcast waves or the Internet, or provided in the form of various media, such as DVDs.

Content may be a television program distributed by television broadcasting where the television program is received by the television tuner 271 and displayed in the window 252-2 of the plurality of windows 252 in the display screen 251

The operation area 261 includes various buttons or controllers for operating a television program displayed in the television program display area 262. In the example shown in FIG. 3, the operation area 261 includes volume buttons 261a, channel selection buttons 261b and 261j, a stop button 261c, a pause button 261d, a playback button 261e, a rewind button 261f, a fast-forward button 261g, skip buttons 261h and 261i, a channel display portion 261k, and a record button 261m.

The volume buttons 261a are used for adjusting the volume of the television program displayed in the television program display area 262. The playback button 261e is used for replaying back (redisplaying) video after the playback of the video has been stopped. The stop button 261c is used for stopping displaying video. The rewind button 261f and the fast-forward button 261g are respectively used for rewinding and fast-forwarding video.

The pause button 261d is used for temporarily interrupting the playback of video while allowing the video to remain displayed. The skip buttons 261h and 261i are used for skipping video (content) in the backward direction or in the forward direction, respectively, for a predetermined time (for example, five seconds).

The channel selection buttons 261b and 261j are used for selecting channels. The channel selection buttons 261j, which serves as a numerical keypad, are used for directly inputting a desired channel number, and the channel selection buttons 261b are used for selecting a channel by sequentially switching channels.

The record button 261m is used for recording selected video (content). By pressing or selecting the record button 261m, a recorder 109 (FIG. 1), which is discussed below, starts recording a television program of a channel selected through the channel selection button 261b or 261j. In the channel display portion 261k, a channel number and/or a broadcast station name corresponding to a channel which is currently being received may be indicated.

The volume buttons 261a, the channel selection buttons 261b and 261j, the stop button 261c, the pause button 261d, the playback button 261e, the rewind button 261f, the fast-forward button 261g, the skip buttons 261h and 261j, the channel display portion 261k, and the record button 261m can be selected or input by the user operating a pointer 253 by the use of the mouse 24.

Operation history of various input operations performed in the operation area 261 may be stored by an operation history generator 110, which is discussed in further detail below.

In the window 252-1, word-processing (program) is being executed, and the user can enter data (for example, input text) in the window 252-1 by the use of the keyboard 22 or the mouse 24.

In the word-processing executed in the window 252-1, the input data such as text can be implemented using the keyboard 22 or the mouse 24 only when the window 252-1 is in the active state.

The television tuner 271 is a receiver that can receive television programs (content) that are broadcast via broadcast waves through an antenna (not shown), and may serve as the content acquisition unit 26 that acquires content data. The television tuner 271 also serves as the content information acquisition unit 27 that acquires information concerning content acquired by the content acquisition unit 26.

As program information, for example, an electronic program guide (EPG), can be used, and the television tuner 271 (the content information acquisition unit 27) can receive, for example, ADAMS-EPG, distributed as data broadcasting to acquire, for example, program names and broadcast times, as the program information.

The keyboard 22 and the mouse 24 serve as input units for allowing the user (viewer) of the information processing apparatus 100 to input various items of information or to perform operations. The keyboard 22 is an input unit for inputting characters, and the mouse 24 is an input unit for moving the pointer 253 displayed in the display screen 251 or performing various selection operations and window operations (such as moving windows changing the size of windows etc).

The user may input characters by the use of the keyboard 22 in the window 252-1 in which word-processing is being executed. Alternatively, the mouse 24, the user may switches through the plurality of windows 252, move the window 252, change the size of the window 252, or perform operations, such as volume control, fast-forward, rewind, playback, or stop, in the window 252-2 in which the television program display program is being executed.

The HDD 23 is a storage unit that can store therein an OS, various applications, various data, etc., and also stores (records) therein data of television programs received by the television tuner 271 and an operation history generated by the operation history generator 110, which is discussed in further detail below.

The I/O controller 28 controls input/output devices, such as the keyboard 22, the mouse 24, and the HDD 23, used in the information processing apparatus 100. For example, the I/O controller 28 delivers information input through the keyboard 22 or the mouse 24 to the CPU 10, an apparatus processing state information acquisition unit 108, or the operation history generator 110, or delivers various items of data received by the television tuner 271 to the CPU 10 or controls reading or writing of data from or into the HDD 23.

The ROM 30 stores therein various data and programs, and the CPU 10 implements various functions using the programs or data stored in the ROM 30 or the HDD 23.

The RAM 29 is enabled to temporarily store therein various data and programs, and may be used for, for example, temporarily expanding such various data and programs when the CPU 10 executes computation processing.

The CPU 10 implements various functions by executing various computation operations based on the programs or data stored in the ROM 30 or the HDD 23.

The information processing apparatus 100 has a preference-data generating function of generating preference data concerning preferences of a user (viewer) for television programs displayed in the window 252-2, which is one screen area among the plurality of windows 252 displayed in the display screen 251 of the display 25. The information processing apparatus 100 also has a notifying function of notifying the user of the generation of a predetermined event of a television program displayed in the window 252-2.

### A. Description of Preference-Data Generating Function

Description of the preference-data generating function of the information processing apparatus 100 is set forth below.

FIG. 1 illustrates the functional configuration for implementing the preference-data generating function in the information processing apparatus 100. To implement the preference-data generating function, the CPU 10 serves as, as shown in FIG. 1, the display controller 101, a state information acquisition unit 102, a preference evaluation value calculator 104, the apparatus processing state information acquisition unit 108, a preference reference value calculator 105, a preference data generator 107, a content playback unit 106, a recorder 109, and the operation history generator 110.

The content playback unit 106 plays back content data obtained by the content acquisition unit 26. Obtaining content data can be implemented by executing the television program display program by the CPU 10. The content played back by the content playback unit 106 may be displayed in the window 252-2 (FIG. 3).

The display controller 101 controls the plurality of windows 252 to be displayed in the display screen 251 of the display 25 and various information to be displayed in the window 252. The display controller 101 also performs various control operations so that content played back by the content playback unit 106 can be displayed in the television program display area 262 of the window 252-2.

In the HDD 23, various setting values used for displaying content in the window 252-2, such as the size, the position, the volume, the audio language (if multilingual playback is possible), and the language of a subtitle (if multilingual display is possible), of the window 252-2 are stored as content display setting information. When displaying content in the display 25, the content playback unit 106 and the display controller 101 check for content display setting information in the HDD 23, and if content display setting information is stored, the content is displayed based on the content display setting information.

In the HDD 23, initial setting values which are initially set as the content display setting information are also stored. For content without content display setting information, the content playback unit 106 and the display controller 101 obtain the initial setting values from the HDD 23 and apply the setting values as the content display setting information.

The operation history generator 110 generates the history of operations performed by the user using the keyboard 22 or the mouse 24. For example, the operation history generator 110 generates, as the operation history, information concerning types and numbers of operations performed in the operation area 261 by the use of the keyboard 22 or the mouse 24 such as volume control, fast-forward, and rewind, while the content data played back by the content playback unit 106 is being displayed in the window 252-2. The operation history generator 110 stores the generated operation history in a storage area of the HDD 23 or the RAM 29 in association with information concerning the content.

When the content playback unit 106 plays back content, such as a television program recorded in the HDD 23, the operation history generator 110 also records the number of playback operations (display operations).

On the basis of the operation history of the display of the content in the information processing apparatus 100, the preference reference value calculator 105 calculates a preference reference value concerning the content. More specifically, the preference reference value calculator 105 obtains the operation history generated by the operation history generator 110 and calculates the preference reference value based on the operation history.

The preference reference value represents a level of the user's preference (such as a numerical value) for a certain item of content, and is a value generated based on the operation history of operations performed by the user while the content is being displayed.

For example, if, during the display of content in the television program display area 262, the user increases the volume by operating the volume button 261a, performs recording by using the record button 261m, or performs rewinding by operating the rewind button 261f or the skip button 261h in the display screen 251, a level of the user's preference is considered to be high and the preference reference value is increased.

In contrast, if, during the display of content in the television program display area 262, the user decreases the volume by operating the volume button 261a, changes the channel by operating the channel selection button 261b or 261j, or performs fast-forward by operating the fast-forward button 261g or the skip button 261i in the display screen 251, a level of the user's preference is considered to be low and the preference reference value is decreased.

Various methods and techniques for calculating a preference reference value by the preference reference value calculator 105 are available. The preference reference value is calculated as the function F based on a coefficient reflecting operation history. The preference reference value may be hereinafter represented by the function F (α) or the function F. The coefficient α is generated in accordance with the operation history (for example, input/selection operations performed by the user in the display screen 251). Various coefficients α may be set.

The apparatus processing state information acquisition unit 108 acquires apparatus processing state information concerning a state of processing executed by the information processing apparatus 100. The apparatus processing state information is information concerning various states of hardware or software that can be changed by executing processing by the information processing apparatus 100, for example, a usage level of resources of the CPU 10 or the amount of access (amount of data transfer) to the HDD 23.

The amount of access to the HOD 23 can be represented by the write-time/write-byte taken for writing data to the HDD 23. The apparatus processing state information acquisition unit 108 can obtain the apparatus processing state information from the CPU 10 or the I/O controller 28.

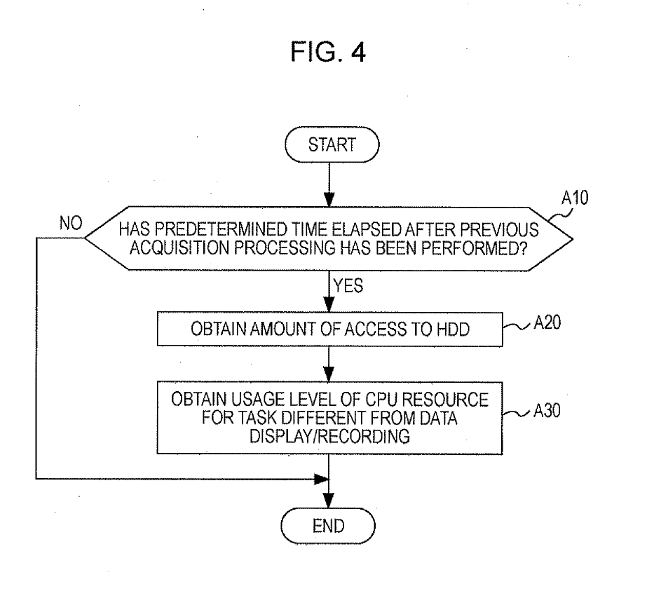

An example of a method for acquiring the apparatus processing state information by the apparatus processing state information acquisition unit 108 of the information processing apparatus is described in further detail below with reference to the flowchart (operations A10 through A30) in FIG. 4.

The apparatus processing state information acquisition unit 108 determines in operation A10 whether a predetermined time has elapsed after previous apparatus processing state information has been obtained or performed. When the predetermined time has elapsed, the process proceeds to operation A20. In operation A20, information concerning an amount of access to the HDD 23 is obtained from the I/O controller 28 or the CPU 10. Then, in operation A30, a usage level (usage rate) of a resource of the CPU 10 is obtained so that the usage rate (%) of the CPU resource used by a task concerning software other than the television program display program executed in the window 262-2 can be calculated.

When determining in operation A10 that the predetermined time has not elapsed after the previous acquisition processing has been obtained, the processing is terminated because the apparatus processing state information has not considerably changed.

The amount of access to the HDD 23 or the usage level of the CPU resource obtained by the apparatus processing state information acquisition unit 108 is stored in the HDD 23, the RAM 29, or another storage device (not shown).

In the flowchart in FIG. 4, the order in which operation A20 and A30 are executed is not restricted to the order shown in FIG. 4. Alternatively, operation A30 may be executed first, and then, operation A20 may be executed.

If the apparatus processing state information acquisition unit 108 obtains apparatus processing state information other than the usage level of the CPU resource or the amount of access to the HDD 23, it may obtain such apparatus processing state information at a certain time or at predetermined intervals.

The state information acquisition unit 102 acquires state information concerning the window 252 displayed in the display screen 251 of the display 25. The state information indicates the display state of the window 252 displayed in the display screen 251 of the display 25. The state information includes content display screen area display information concerning the display state of the window 252-2 in which content is displayed among the plurality of windows 252 displayed in the display screen 251 and also includes screen area processing state information concerning the processing states of the plurality of windows 252 in the information processing apparatus 100.

The content display screen area display information indicates the state of the window 252-2 (window size or active/non-active state) in which content is displayed and the time for which such a state is maintained (such a time may be referred to as the “window-state continuation time”).

The screen area processing state information indicates, when the plurality of windows 252 including the window 252-2 are displayed in the display screen 251, a frequency (number) of switching operations for changing the active state between the window 252-2 and the other windows 252 in the display screen 251 of the display 25 or the state of input operations (frequency or number of inputs) on the windows 252 other than the window 252-2 in which content is displayed.

The state of input operations in the other windows 252 can be calculated as follows. Information concerning the input operations performed in, for example, the window 252-1 in which word-processing is being executed by the use of the keyboard 22, the mouse 24, and other input devices, for example, a touch panel (not shown), is obtained, and then, such input operations are calculated as the number of inputs per unit time. As the screen area processing state information, information concerning the state in which the window 252-2 is overlapped with the other windows 252 (such as information concerning which window is displayed in front or the area ratio of the portion is overlapped to the portion not being overlapped) may be used.

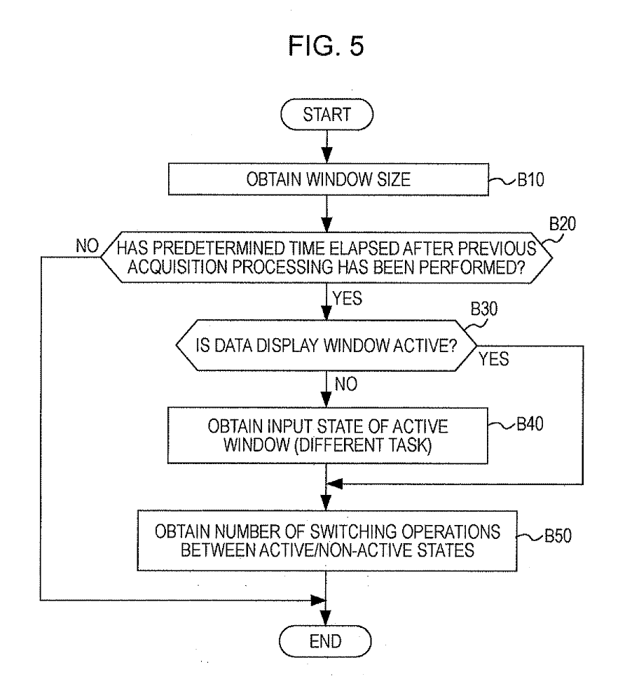

A description is now given, with reference to the flowchart (operations B10 through B50) in FIG. 5, of a method for acquiring state information by the state information acquisition unit 102 of the information processing apparatus 100.

In operation B10, the state information acquisition unit 102 obtains, from the display controller 101, the window size of the window 252-2 in which a television program is displayed and window sizes of the other windows 252 in the display screen 251 of the display 25. The state information acquisition unit 102 also obtains times for which the window 252-2 and the other windows 252 are maintained at the same window sizes. Then, it is determined in operation B20 whether a predetermined time has elapsed after the previous state information has been obtained.

When determining in operation B20 that the predetermined time has elapsed, the process proceeds to operation B30 to determine whether the window 252-2 in which a television program is displayed is in an active state. If the window 252-2 is not in the active state, the process proceeds to operation B40. In operation B40, the input state in the window 252 in the active state by the use of the keyboard 22 or the mouse 24 (i.e., a task concerning software other than the television program display program executed in the window 252-2) is obtained.

Then, in operation B50, the state information acquisition unit 102 obtains a frequency (number) of switching operations for changing the active state between the window 252-2 and the other windows 252. The processing is then completed.

When determining in operation B30 that the window 252-2 in which a television program is displayed is in the active state, the process proceeds to operation B50.

When determining in operation B20 that the predetermined time has not elapsed after the previous acquisition processing has been obtained, the processing is terminated because the state information has not considerably changed.

The window size of the window 252-2 in which a television program is displayed and the window sizes of the other windows 252 and the times for which the window 252-2 and the windows 252 are maintained at the same window sizes (such a time may be referred to as the “window-size continuation time”), information as to whether the predetermined time has elapsed, and information (state information) concerning the number of switching operations for changing the active state between the window 252-2 and the other windows 252 obtained by the state information acquisition unit 252 are stored in the HDD 23, the RAM 29, or another storage device (not shown).

The preference evaluation value calculator 104 calculates the preference evaluation values concerning the content displayed in the window 252-2 based on the state information obtained by the state information acquisition unit 102.

The preference evaluation values are the numerical value for calculating preference data of the user (viewer) concerning the content displayed in the window 252-2 in the display screen 251, and are calculated based on the above-described state information and apparatus processing state information. In the information processing apparatus 100, the preference evaluation values are used as correction values for correcting the preference reference value calculated by the preference reference value calculator 105.

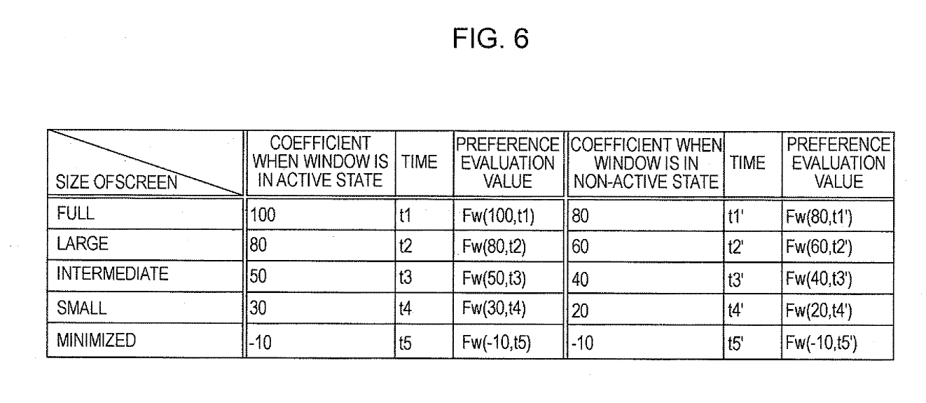

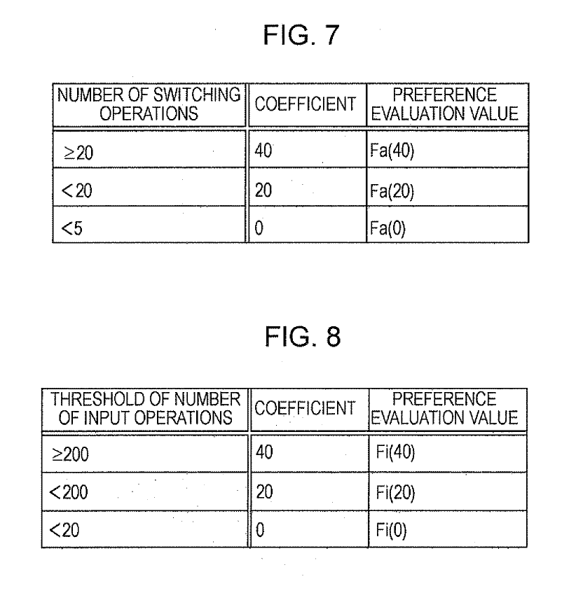

FIGS. 6 through 8 illustrate approaches to calculating preference evaluation values by the preference evaluation value calculator 104 in the information processing apparatus 100. FIG. 6 illustrates an example in which the preference evaluation values are calculated based on content display screen area display information. FIGS. 7 and 8 illustrate examples in which the preference evaluation values are calculated on the basis of screen area processing state information.

In the example shown in FIG. 6, the preference evaluation values are calculated by using, as the content display screen area display information, the window sizes of the window 252-2 and the window-size continuation times depending on whether the window 252-2 is in the active state or in the non-active state.

In the example shown in FIG. 6, the sizes of the window 252 are divided into five size ranges, such as “full” (full screen), “large”, “intermediate”, “small”, and “minimized” (non-display), and the coefficient is set for each size of the window 252 depending on whether the window 252 is in the active state or in the non-active state.

The “full screen” is the state in which the window 252 is displayed in the entire area of the display screen 251 (maximum size), and the window 252-2 in which a television program is displayed is displayed in the entire area of the display screen 251 by the use of, for example, the maximize function of Microsoft Windows®. The “minimized” state is the state in which the window 252-2 or at least the television program display area 262 is not displayed in the display screen 251 (non-display state), and is the state in which only a tool bar is displayed in the display screen 251 by the minimize function of Microsoft Windows®.

Whether the window 252 is classified as the “large”, “intermediate”, or “small” size is determined by the actual size of the window 252 or the size ratio of the window 252 to the display screen 251, and the window 252 is classified as one of the above size ranges on the basis of the size of the window 252-2 in which a television program is displayed. The time indicates the continuation time for which the size of the window 252-2 is maintained (unit:seconds) (window-size continuation time).

For example, if the window 252-2 in which a television program is displayed is in the active state, the possibility that the user watches this television program is high, and as the window size of the window 252-2 is larger, it is more likely that the user is interested in the television program (the level of preference is higher). Based on this assumption, a large coefficient is set. That is, in the information processing apparatus 100, the size of the window 252-2 and information as to whether the window 252-2 is in the active or non-active state are used for determining the user's preferences.

The preference evaluation value is calculated as the function Fw based on the coefficient reflecting the window size and the window-size continuation time depending on whether the window is in the active state or in non-active state. For example, if the window 252-2 is displayed in the full size for 30 minutes, the coefficient 100 is selected, and the preference evaluation value calculator 104 calculates the preference evaluation value from the function Fw (100, 30). The preference evaluation value calculated based on the function Fw may be hereinafter referred to as the “preference evaluation value Fw”.

The function Fw is a preset function using, as the variables, the coefficient depending on whether the window is in the active or in the non-active state and the window-size continuation time. The function Fw and the coefficient depending on whether the window is in the active or in the non-active states can be varied.

The size of the window 252 may be classified as one of the five size ranges “full”, “large”, “intermediate”, “small”, and “minimized”, and the coefficient may be set for each size of the window 252 depending on whether the window 252 is in the active state or in the non-active state. However, the size ranges are not restricted to the above-described ranges, and the number of size ranges may be four or less or six or more. Various modifications may be made within the scope of the invention.

In the example shown in FIG. 7, the preference evaluation value is calculated based on the coefficient reflecting the number of switching operations for changing the active window between the window 252-2 and the other windows 252.

In the example shown in FIG. 7, the number of switching operations are divided into three ranges, such as “4 or less”, “from 5 to 19”, “20 or more”, and different coefficients (0, 20, 40) are set for the corresponding ranges.

The preference evaluation value is calculated as the function Fa based on the coefficient reflecting the number of switching operations. For example, if 10 switching operations for changing the active window from the window 252-2 to another window 252 are performed, the coefficient 20 is selected, and the preference evaluation value is calculated from the function Fa (20). The preference evaluation value calculated from the function Fa may be referred to as the “preference evaluation value Fa”.

The function Fa is a preset function using, as the variable, the coefficient reflecting the number of switching operations for changing the active window between the window 252-2 and the windows 252. The function Fa and the coefficient reflecting the number of switching operations can be varied.

The number of switching operations for changing the active window may be divided into three ranges, such as “4 or less”, “from 5 to 19”, and “20 or more”, and the coefficient may be set for each range. However, the ranges into which the numbers of switching operations are divided are not restricted to the above-described ranges, and the number of ranges may be two or less, or four or more. Various modifications may be made within the concept of the invention.

In the example shown in FIG. 8, the preference evaluation value is calculated on the basis of the coefficient reflecting the number of input operations performed through an input unit, such as the keyboard 22 or the mouse 24, in the window 252 different from the window 252-2. The number of input operations is divided into three ranges, such as “119 or less”, “from 20 to 199”, and “200 or more” and different coefficients (0, 20, 40) are set for the corresponding ranges.

The preference evaluation value is calculated as the function Fi based on the coefficient reflecting the number of input operations. For example, if 150 input operations are performed in the window 252 different from the window 252-2, the coefficient 20 is selected, and the preference evaluation value is calculated from the function Fi (20). Hereinafter, the preference evaluation value calculated from the function Fi may be referred to as the “preference evaluation value Fi”.

The function Fi is a preset function using, as the variable, the coefficient reflecting the number of input operations (such as typing, click, etc.) by the use of the keyboard 22 or the mouse 24 in the window 252 different from the window 252-2. The function Fi and the coefficient reflecting the number of input operations can be varied.

The input operations performed in the window 252 different from the window 252-2 may be divided into three ranges, such as “119 or less”, “from 20 to 199”, and “200 or more”, and the coefficient may be set for each range. However, the ranges into which the numbers of input operations are divided are not restricted to the above-described ranges, and the number of ranges may be two or less or four or more. Various modifications may be made within the concept of the invention.

While the plurality of windows 252 are displayed in the display screen 251, if the window 252-2 in which a television program is displayed is concealed by another window 252 (for example, the window 252-1), if the active window is frequently switched between the window 252-2 and another window 252, and/or if input operations are frequently performed by the use of the keyboard 22 or the mouse 24 in another window 252, it can be determined that a priority is given to the processing performed in the window 252, i.e., the user is not paying attention to the television program displayed in the window 252-2.

Accordingly, in the information processing apparatus 100, the switching operation for changing the active/non-active states among the plurality of windows 252 in the display screen 251 and the number of input operations in the window 252-2 or in the other windows 252 may be used for determining the user's preferences.

The preference evaluation value calculator 104 calculates the preference evaluation value concerning the content displayed in the window 252-2, also based on the apparatus processing state information obtained by the apparatus processing state information acquisition unit 108. In the information processing apparatus 100, the preference evaluation value calculated based on the apparatus processing state information is also used for correcting the preference reference value calculated by the preference reference value calculator 105.

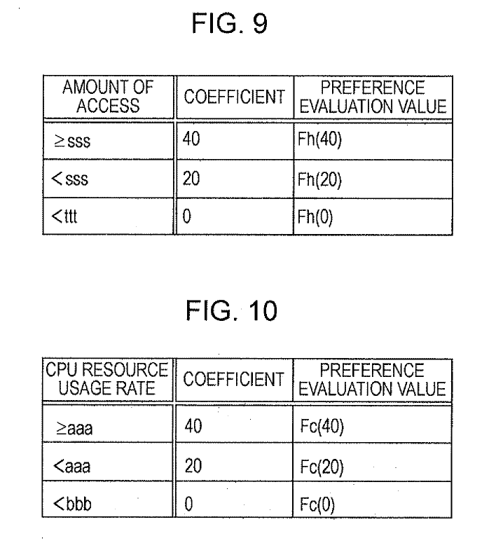

FIGS. 9 and 10 illustrate methods for calculating preference evaluation values by the preference evaluation value calculator 104 in the information processing apparatus 100. In both the examples illustrated in FIGS. 9 and 10, the preference evaluation values are calculated based on the apparatus processing state information obtained by the apparatus processing state information acquisition unit 108.

In the example shown in FIG. 9, by the use of the amount of access to the HDD 23 as the apparatus processing state information, the preference evaluation values are calculated. The amounts of access to the HDD 23 are classified as three ranges, such as “less than ttt”, “from ttt to less than sss”, and “sss or more”, and the different coefficients (0, 20, 40) are set for the corresponding ranges of the amounts of access. The amounts of access ttt and sss are represented by preset numerical values indicating the amounts of access to the HDD23. They are represented by, for example, the write-time/write-byte.

Generally, when television program data stored in the HDD 23 is displayed, the amount of access accompanied by reading from the HDD 23 is relatively increased, and on the other hand, the amount of access accompanied by writing to the HDD 23 is not increased. Accordingly, if write access is frequently made to the HDD 23, it is highly likely that the user performs processing accompanied by write access by the use of the information processing apparatus 100, and is not paying attention to the television program displayed in the window 252-2.

The preference evaluation value is calculated as the function Fh based on the coefficient reflecting the amount of access to the HDD 23. If the amount of access accompanied by writing to the HDD 23 is sss or more, the coefficient 40 is selected, and the preference evaluation value is calculated from the function Fh (40). The preference evaluation value calculated from the function Fh may be hereinafter referred to as the “preference evaluation value Fh”.

The function Fh may be a preset function using, as the variable, the coefficient reflecting the amount of access accompanied by writing to the HDD 23. The function Fh and the coefficient reflecting the amount of write access can be varied.

The ranges into which the amounts of access accompanied by writing to the HDD 23 are divided are not restricted to the above-described ranges, and the number of ranges may be two or less or four or more. Various modifications may be made within the concept of the invention.

In the example shown in FIG. 10, to calculate the preference reference value, the rate (%) of the usage (usage rate) of the resource of the CPU 10 used by a task concerning software other than the television program display program executed in the window 252-2 is used as the apparatus processing state information. The usage rates are classified as three ranges, such as “less than bbb”, “from bbb to less than aaa”, and “aaa or more”, and different coefficients (0, 20, 40) are set for the corresponding ranges.

The usage rates aaa and bbb are represented by preset numerical values indicating the usage rates of the CPU resource.

The usage rate of the CPU resource used by a task concerning software other than the television program display program executed in the window 252-2 may be determined by averaging the usage rates per unit time. Based on this averaged value, the preference evaluation value can be calculated.

For example, in the information processing apparatus 100, it is now assumed that a load of the CPU 10 imposed on the display processing of television program data is relatively low and that, as a result of checking for a task executed (operated) by the CPU 10 simultaneously with the display of a television program in the window 252-2, it is determined that a task for a program not related to the television program display program executed in the window 252-2 uses a large part of the resource of the CPU 10. In this case, it can be seen that the information processing apparatus 100 is used for a purpose other than the display of a television program. That is, it is highly likely that the user is not paying attention to the television program displayed in the window 252-2. If new tasks are frequently generated, it can also be determined that the user is performing other work or task by the use of the information processing apparatus 100 and is not paying attention to the television program.

The preference evaluation value is calculated as the function Fc based on the coefficient reflecting the usage rate of the CPU resource. For example, if the usage rate of the CPU resource used by software other than the television program display program executed in the window 252-2 is aaa or more, the coefficient 40 is selected, and the preference evaluation value is calculated from the function Fc (40). The preference evaluation value may be hereinafter referred to as the “preference evaluation value Fc”.

The function Fc is a preset function using, as the variable, the coefficient reflecting the usage rate of the CPU resource used by a task concerning a software or other resource(s) different from the television program display program executed in the window 252-2. The function Fc and the coefficient reflecting the usage rate of the CPU resource can be varied.

The ranges as which the usage rates of the CPU resource may be classified are not restricted to the above-described ranges, and the number of ranges may be two or less or four or more. Various modifications may be made within the concept of the invention.

The preference data generator 107 generates preference data concerning content based on the preference evaluation values calculated by the preference evaluation value calculator 104. According to the information processing apparatus 100, preference data may be generated based on the preference reference value calculated by the preference reference calculator 105 and the preference evaluation values (Fw, Fa, Fi, Fh, Fc) calculated by the preference evaluation value calculator 104.

More specifically, the preference data generator 107 applies, as correction values, the preference evaluation values calculated by the preference evaluation value calculator 104 to the preference reference value calculated by the preference reference value calculator 105 to generate the preference value (preference data). For example, the preference data generator 107 multiplies each of the preference evaluation values shown in FIGS. 6 through 10 by a predetermined coefficient K to calculate a correction value. Then, the preference data generator 107 adds the correction value to the preference reference value to calculate the preference value.

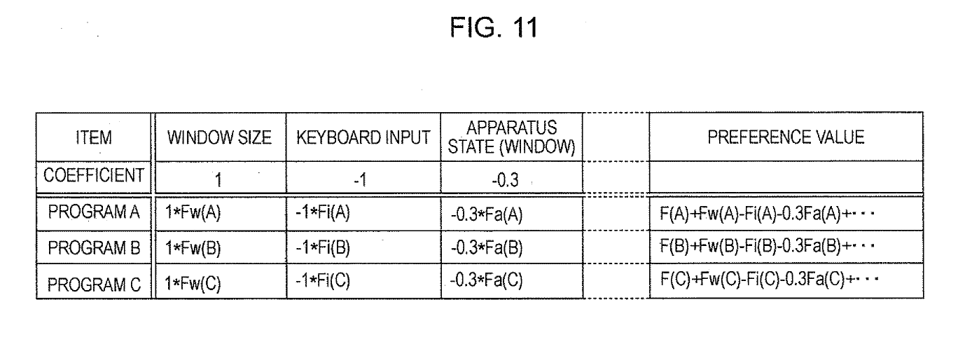

FIG. 11 illustrates a method (process) for generating preference values (preference data) in the information processing apparatus 100.

In FIG. 11, a method for calculating a preference value for each of the television programs A, B, and C is shown. The coefficient K=1.0 is set for the function Fw, represented by the item “window size”, reflecting the window size of the window 252-2 and the window-size continuation time. The coefficient K=−1.0 is set for the function Fi, represented by the item “keyboard input”, reflecting the number of input operations in the window 252 other than the window 252-2. The coefficient K=−0.3 is set for the function Fa, represented by the item “apparatus state”, reflecting the number of switching operations for changing the active window between the window 252-2 and the other windows 252.

The preference value is calculated by adding some or all of the correction values calculated by multiplying each of the above-described preference evaluation values Fw, Fa, Fi, Fh, and Fc by the predetermined coefficient K to the preference reference value F. In the example shown in FIG. 11, the preference values are calculated by adding the correction values calculated at least based on the preference evaluation values Fw, Fi, and Fa to the preference reference value F.

In FIG. 11, for the sake of convenience, the function F representing the preference reference value is followed by one of the capital letters A, B, and C with parentheses to indicate which of the programs A, B, and C concerns the preference reference value. Similarly, for the sake of convenience, in FIG. 11, the functions Fw, Fi, and Fa representing the preference evaluation values are followed by one of the capital letters A, B, and C with parentheses to indicate which of the programs A, B, and C concerns the preference evaluation values. In FIG. 11, for simplicity of representation, the preference evaluation values Fc and Fh are not shown.

In FIG. 11, for example, the preference evaluation value Fw(A) is calculated from the function Fw based on the coefficient reflecting the window size and the window-size continuation time depending on whether the window 252-2 in which the program A is displayed is in the active state or in the non-active state.

For example, to calculate the preference value of the program A, the preference data generator 107 calculates, as shown in FIG. 11, the preference value by adding 1×Fw(A), which is obtained by multiplying the preference evaluation value Fw(A) by the coefficient K=1, −1×Fi(A), which is obtained by multiplying the preference evaluation value Fi(A) by the coefficient K=−1, and −3×Fa(A), which is obtained by multiplying the preference evaluation value Fa(A) by the coefficient K=−3, to the preference reference value F(A), as expressed by equation (1).

Preference value=F(A)+1×Fw(A)+(−1)×Fi(A)+(−3)×Fa(A)+ . . . (1)

The preference data generator 107 stores generated preference values (preference data) in the HDD 23 in association with information for specifying the corresponding television programs.

When calculating the preference value for a television program displayed in the television program display area 262 in the window 252-2, if the preference value for the television program is already stored in the HDD 23, the preference data generator 107 obtains the preference value stored in the HDD 23 and reflects a new preference value in the stored reference value (old reference value).

For example, the preference data generator 107 uses the average of the new preference value and the old preference value as the preference value.

Alternatively, the preference data generator 107 may generate preference data in the following manner. Instead of using the preference reference value calculated by the preference reference value calculator 105, the old preference value may be used, and the preference evaluation value multiplied by each coefficient may be added to the old preference value. Alternatively, instead of reflecting the old preference value in the new preference value, the preference data generator 107 may update the old preference value by the new preference value. That is, the old preference value may be canceled, and the new preference value may be used instead.

The recorder 109 records television programs obtained by the content acquisition unit 26. For example, if the user selects (presses) the record button 261m or gives an instruction to perform recording by the use of a reserve-record function in the television program display area 262 of the display screen 251, the recorder 109 records the corresponding television program in the HDD 23. When recording a television program, the recorder 109 also records EPG data related to the television program obtained by the television tuner 271 (content information acquisition unit 27) and the preference value generated by the preference data generator 107 in association with the television program.

The recorder 109 also has a reserve-recording function of selecting television programs that match the preset user's preference on the basis of the content information obtained by the content information acquisition unit 27 and of automatically recording the selected television programs.

Television program data (content data) to be recorded are stored in a storage unit, such as the HDD 23, or a recording medium, such as a DVD (not shown).

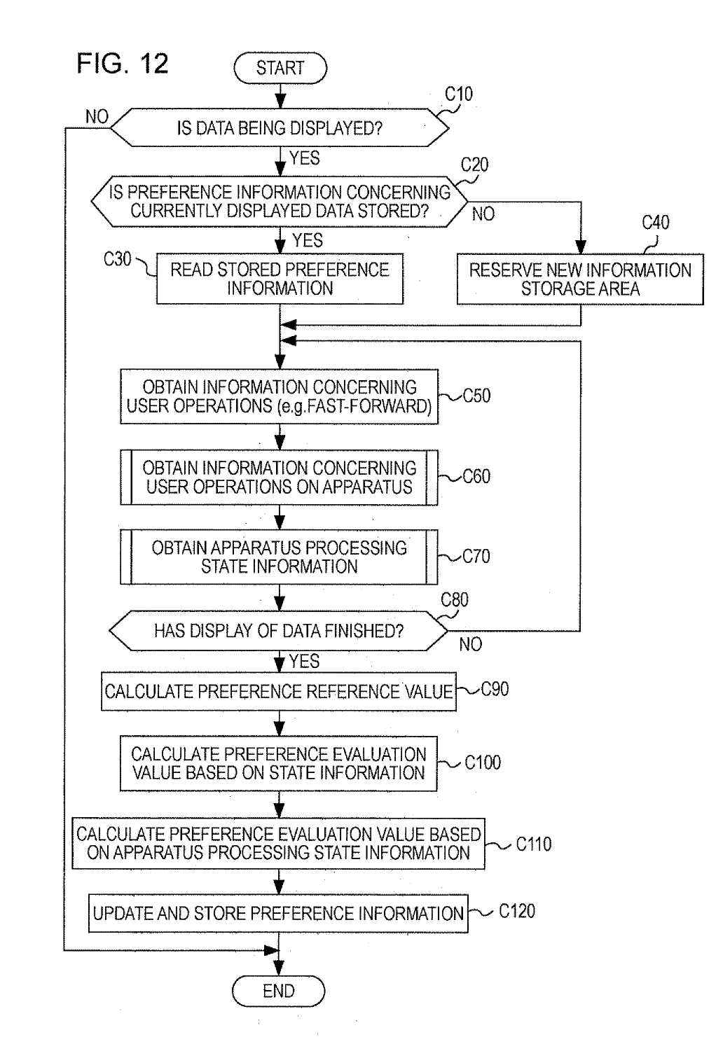

A description is now given, with reference to the flowchart (operations C10 through C120) in FIG. 12, of a method (process) for obtaining preference information by analyzing user's preferences when displaying a television program in the information processing apparatus 100.

In the information processing apparatus 100, the content acquisition unit 26 receives television program data. Then, the content playback unit 106 plays back the received television program data, and the display controller 101 displays the played back television program in the television program display area 262 of the window 252-2 in the display screen 251 of the display 25. In this case, the content playback unit 106 and the display controller 101 also obtain content display setting information from the HDD 23, and display the television program on the basis of the content display setting information.

In operation C10, the CPU 10 determines whether a television program is being displayed in the display screen 251. If a television program is not displayed, the processing is terminated. If a television program is displayed, the process proceeds to operation C20. In operation S20, the preference data generator 107 determines whether a preference value (preference information) concerning the television program displayed in the window 252-2 is stored in the HDD 23.

If a preference value concerning the television program is already stored in the HDD 23, the process proceeds to operation C30. In operation C30, the preference data generator 107 reads the stored preference value.

Then, in operation C50, while the television program is being displayed in the window 252-2, the operation history generator 110 obtains, as the operation history, operation information concerning operations, such as fast-forward or volume control, performed by the user in the window 252-2 by the use of the keyboard 22 or the mouse 24. Then, in operation C60, the state information acquisition unit 102 obtains state information concerning the window 252-2 in the display screen 251 of the display 25. The method for obtaining the state information by the state information acquisition unit 102 has been discussed with reference to FIG. 5.

When determining in operation C20 that a preference value concerning the television program displayed in the window 252-2 is not stored in the HDD 23, the process proceeds to operation C40. In operation C40, the preference data generator 107 first reserves an area for storing a preference value to be calculated in the HDD 23, and then proceeds to operation C50.

In operation C70, while the television program is being displayed in the window 252-2, the apparatus processing state information acquisition unit 108 obtains apparatus processing state information. The method for obtaining the apparatus processing state information by the apparatus processing state information acquisition unit 108 has been discussed with reference to FIG. 4.

The CPU 10 then determines in operation C80 whether the playback of the television program has finished, i.e., whether the display of the content data has finished. When determining in operation S80 that the display of the content data has not finished, the process returns to operation C50. If the display of the content data has finished, the process proceeds to operation C90. In operation C90, the preference reference value calculator 105 calculates the preference reference value on the basis of the operation history collected and generated by the operation history generator 110 while the television program is being displayed.

Then, in operation C100, the preference evaluation value calculator 104 calculates the preference evaluation value on the basis of the state information obtained by the state information acquisition unit 102. In operation C110, the preference evaluation value calculator 104 calculates the preference evaluation value on the basis of the apparatus processing state information obtained by the apparatus processing state information acquisition unit 108.

Then, in operation C120, the preference data generator 107 generates a preference value by applying, as correction values, the preference evaluation values calculated by the preference evaluation value calculator 104 to the preference reference value calculated by the preference reference value calculator 105, and then stores the generated preference value in, for example, the HDD 23, in association with the television program. When determining in operation C20 that the preference value for the television program is already stored in the HDD 23, the preference data generator 107 updates the preference value in the HDD 23 by the new preference value. The processing is then completed.

As described above, according to the information processing apparatus 100, the state information acquisition unit 102 may obtain state information concerning the plurality of windows 252 displayed in the display screen 251 of the display 25, and the preference evaluation value calculator 104 calculates preference evaluation values concerning the content on the basis of the obtained state information. Then, the preference data generator 107 generates preference data on the basis of the calculated preference evaluation values. As a result, preference data reflecting the user's preferences can be generated.

Additionally, the preference reference value calculator 105 calculates the preference reference value for the content on the basis of the operation history obtained from the display of the content in the information processing apparatus 100. Then, the preference data generator 107 generates preference data on the basis of the calculated preference reference value and preference evaluation values. As a result, more precise preference data reflecting the user's preferences can be generated.

Additionally, the apparatus processing state information acquisition unit 108 obtains apparatus processing state information concerning the processing executed in the information processing apparatus 100, and the preference evaluation value calculator 104 calculates preference evaluation values on the basis of the apparatus processing state information. With this operation, preference evaluation values can be calculated easily and reliably, and precise preference data reflecting the user's preferences in accordance with the state of the information processing apparatus 100 can be generated.

Additionally, state information can be obtained easily from content display screen area display information concerning the display state of the window 252-2 of the display screen 251 of the display 25 or screen area processing state information concerning the processing state of the plurality of windows 252 in the information processing apparatus 100.

### B. Description of Notifying Function

The information processing apparatus 100 has a notifying function of notifying a user when a predetermined event is detected in a television program displayed in the window 252-2.

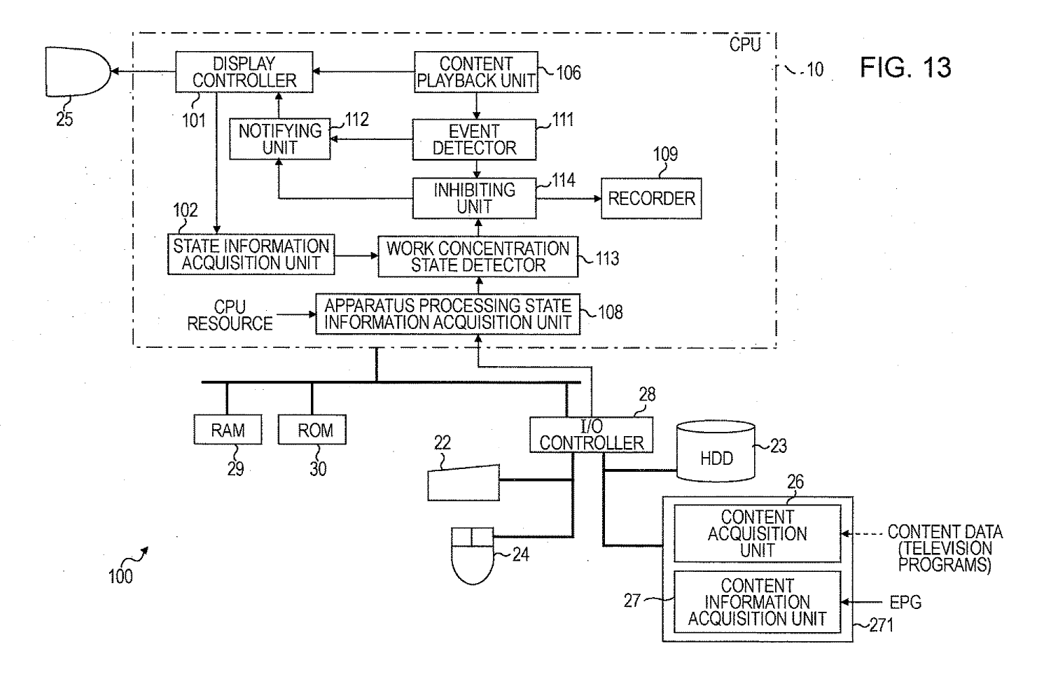

FIG. 13 is a block diagram illustrating the functional configuration for implementing the notifying function in the information processing apparatus 100.

To implement the notifying function, the CPU 10 also serves as, as shown in FIG. 13, the display controller 101, the state information acquisition unit 102, an event detector 111, a notifying unit 112, a work concentration state detector 113, an inhibiting unit 114, and the recorder 109.

For the sake of convenience, in FIG. 13, the preference evaluation value calculator 104, the preference reference value calculator 105, the preference data generator 107, and the operation history generator 110 are not shown. In FIG. 13, elements the same as or substantially the same as those in FIG. 1 are designated with like reference numerals, and an explanation thereof is thus omitted.

The event detector 111 detects a predetermined event concerning a television program displayed in the window 252-2. The event is preset by the user as an event condition, and when an incident that satisfies the event condition is detected in the television program displayed in the window 252-2, the event detector 111 determines that the event has been generated.

The event may be the start of a television program desired (reserved) by a user or a television program of a category (for example, drama, news, or weather forecasts) that highly interests the user, or the display of a user's favorite television star while a television program is being played back, or a change in the content, such as the end of a commercial that has been shown in the halfway of a television program. The event can be variously modified within the concept of the invention.

The event detector 111 can detect the generation of such an event on the basis of, for example, the content played back by the content playback unit 106 or content information obtained by the content information acquisition unit 27. The detection of events can be performed in various known manners.

Upon detecting a predetermined event by the event detector 111, the notifying unit 112 notifies the user of the information processing apparatus 100 of the generation of the event. If, for example, the event detector 111 has detected that a commercial has been finished in the television program displayed in the window 252-2, the notifying unit 112 highlights the window 252-2 by enlarging the size of the window 252-2 in the display screen 251 (enlarged-size or full-size display), or displays a message indicating the detection of an event in the display screen 251.

Notifying events by the notifying unit 112 is not restricted to the above-described approaches, and may be performed in various manners. For example, if the event detector 111 has detected a predetermined event while the window 252-2 is in the non-active state in the display screen 251, the notifying unit 112 may change the window 252-2 to the active state and display the window 252-2 on the front most side in the display screen 251.

It is now assumed that the plurality of windows 252 are displayed in the display screen 251 of the display 25 and that the user performs word-processing in one of the windows 252, e.g., the window 252-1. In this case, if the event detector 111 has detected a predetermined event, the notifying unit 112 can enlarge the size of the window 252-2 to cover the window 252-1 to notify the user of the detection of an event.

Alternatively, the notifying unit 112 may notify the user of the detection of an event by increasing the sound volume in the window 252-2 or by giving an audio message. The user may be notified of the detection of an event in various manners. For example, the method disclosed in Japanese Unexamined Patent Application Publication No. 2004-133733, may be used.

It is possible to preset how to notify the user by the notifying unit 112. Such setting can be made for each piece of content (each television program in this embodiment), and is stored in the HDD 23, as notification setting information, in association with information (for example, a program name) for specifying the content.

The notifying unit 112 checks for notification setting information, and if notification setting information is stored, the notifying unit 112 notifies the user of the detection of an event in accordance with the notification setting information.

In the HDD 23, an initial setting value is also stored as the notification setting information, and for content without notification setting information, the notifying unit 112 obtains the initial setting value from the HDD 23 and applies it as the notification setting information.

The work concentration state detector 113 determines whether the user is concentrating on work, i.e., whether the user is in the work concentration state, in the information processing apparatus 100. When the work concentration state detector 113 determines that the user is concentrating on processing executed in the window 252 other than the window 252-2 in which a television program is displayed, it notifies the inhibiting unit 114 of such a state.

For example, if the work concentration state detector 113 has detected that the user is concentrating on word-processing work executed in the window 252-1 among the plurality of windows 252 displayed in the display screen 251 of the display 25, the work concentration state detector 113 sets a flag indicating the work concentration state in a predetermined storage area of the RAM 29 or the HDD 23 to notify the inhibiting unit 114 of a work concentration state.

The work concentration state detector 113 detects the work concentration state based on, for example, state information obtained by the state information acquisition unit 102.

For example, the work concentration state detector 113 determines whether the user is in the work concentration state on the basis of the state (window size, active/non-active state, etc.) of the window 252-2 in which content is displayed and the continuation time for which such a state is maintained, a frequency of switching operations for changing the active window between the window 252-2 and the other windows 252 in the display screen 251 of the display 25, the state (frequency or number) of input operations in the window 252 other than the window 252-2 in which content is displayed, information concerning how the window 252-2 is overlapped with the other windows 252 (such as information concerning which window is displayed in front or the area ratio of the portion being overlapped to the portion not being overlapped), etc. When at least one of the following states is detected: the time for which the window 252-2 remains in the non-active state is long (the time is longer than a preset threshold); switching operations for changing the active state between the window 252-2 and the other windows 252 are frequently performed (the frequency is larger than a preset threshold); the number of input operations in the windows 252 other than the window 252-2 is large (larger than a preset threshold); and/or another window 252 is positioned in front of the window 252-2, the work concentration state detector 113 determines that the user is in the work concentration state.

The work concentration state detector 113 also determines whether the user is in the work concentration state, based on apparatus processing state information obtained by the apparatus processing state information acquisition unit 108.

For example, the work concentration state detector 113 determines whether the user is in the work concentration state on the basis of the usage level of the CPU resource or the amount of access (data transfer amount) to the HDD 23. If the usage level of the CPU resource used by a task concerning software other than the television program display program executed in the window 252-2 is high, or if the amount of access (write-time/write-byte) to the HDD 23 is large (larger than a preset threshold), the work concentration state detector 113 determines that the user is in the work concentration state.

The state of input operations performed on the other windows 252 can be determined in the following manner. Input operations performed on the window 252-1 in which word-processing is executed by the use of the keyboard 22, the mouse 24, or other input devices (e.g., touch panel) are obtained, and calculated as the number of input operations per unit time. Additionally, as the screen area processing state information, information concerning the overlapping state with the other windows 252 (such as information concerning which window is displayed in front or the area ratio of the portion is overlapped to the portion not being overlapped) may be used.

The manner of notifying the inhibiting unit 114 of the work concentration state by the work concentration state detector 113 is not restricted to the above-described approach using a flag, and may be variously changed within the concept of the invention.

The inhibiting unit 114 inhibits the notifying unit 112 from notifying the user of the generation of an event if the work concentration state detector 108 determines that the user is in the work concentration state. For example, the inhibiting unit 114 inhibits the notifying unit 112 from enlarging the size of the window 252-2 in the display screen 251, and instead, decreases or minimizes the size of the window 252-2, or inhibits the notifying unit 112 from displaying a message indicating the detection of an event.

More specifically, the inhibiting unit 114 changes (corrects) the notification setting information stored in the HDD 23 to a setting value that inhibits the window size of the window 252-2 from being changed, or that decreases or minimizes the size of the window 252-2 (non-display state), or that inhibits a message indicating the detection of an event from being displayed.

The inhibiting unit 114 may instruct the recorder 109 to record a television program displayed in the window 252-2, and the recorder 109 may record the television program in the HDD 23.

In this case, the inhibiting unit 114 may minimize the window 252-2 in the display screen 251 to prevent the user from watching the television program.

Instead of changing (correcting) the notification setting information stored in the HDD 23, the inhibiting unit 114 may instruct or control the notifying unit 112 or the display controller 101 to stop enlarging the size of the window 252-2 in the display screen 251, or to decrease or minimize the size of the window 252-2, or to stop displaying a message indicating the detection of an event. Additionally, when instructing the recorder 109 to record the television program displayed in the window 252-2, the inhibiting unit 114 may instruct the display controller 101 to change the window 252-2 to the non-display state.

Changing the setting value of notification setting information by the inhibiting unit 114 is performed in accordance with a notifying method for notifying the user of the detection of an event by the notifying unit 112.

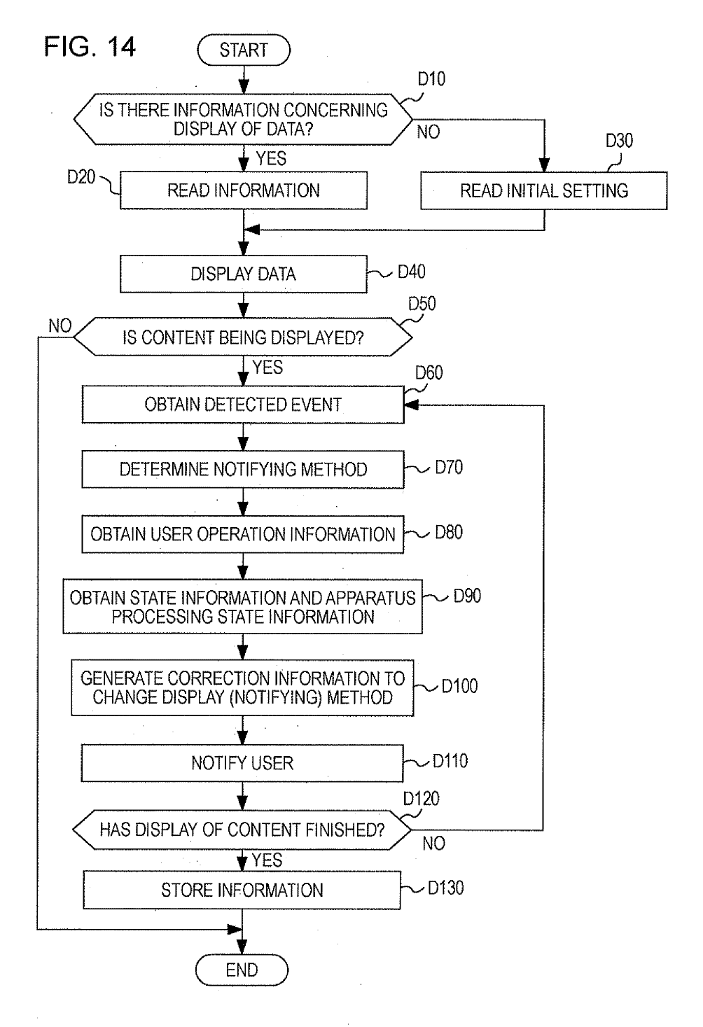

A notifying method for the detection of an event when content is displayed in the information processing apparatus 100 configured in accordance with an embodiment of the present invention is described below with reference to the flowchart (operations D10 through D130) in FIG. 14.

In operation D10, in the information processing apparatus 100, when receiving and displaying television program data by the content acquisition unit 26, the content playback unit 106 and the display controller 101 determine whether content display setting information or notification setting information concerning the television program to be displayed in the windows 252-2 is stored in the HDD 23. If content display setting information or notification setting information is stored, the process proceeds to operation D20 in which such information is read. If content display setting information or notification setting information is not stored, the process proceeds to operation D30. In operation D30, the initial setting value of the content display setting information is read from the HDD 23.

In operation D40, the content playback unit 106 and the display controller 101 display the television program in the window 252-2 of the display 25 on the basis of the content display setting information obtained from the HDD 23.

Then, in operation D50, the event detector 111 checks whether the television program is displayed in the window 252-2. If the television program is not displayed, the processing is terminated. It can be determined that the television program is displayed in the window 252-2 as long as playback processing is performed in a background even if the window 252-2 is minimized in the display screen 251 of the display 25 or even if the window 252-2 is concealed by another window 252 in the active state.

When determining in operation D50 that the television program is displayed in the window 252-2, the process proceeds to operation D60. In operation D60, the event detector 111 checks for a predetermined event concerning the television program displayed in the window 252-2, and if any, the event detector 111 obtains such an event. Then, in operation D70, the notifying unit 112 determines an event notifying method on the basis of the notification setting information.

In operation D80, while the television program is being displayed in the window 252-2, the apparatus processing state information acquisition unit 108 obtains operation information (user operation information), such as fast-forward or volume control, performed by the user by the use of the keyboard 22 or the mouse 24.

In operation D90, the state information acquisition unit 102 obtains state information concerning the window 252-2 displayed in the display screen 251 of the display 25. The method for acquiring state information by the state information acquisition unit 102 has been discussed with reference to FIG. 5. Also in operation D90, the apparatus processing state information acquisition unit 108 obtains apparatus processing state information. The method for acquiring apparatus processing state information by the apparatus processing state information acquisition unit 108 has been discussed with reference to FIG. 4.

In operation D100, the work concentration state detector 113 determines on the basis of the state information obtained by the state information acquisition unit 102 or the apparatus processing state information obtained by the apparatus processing state information acquisition unit 108 whether the user is in the work concentration state in the information processing apparatus 100. If the user is found to be in the work concentration state, the work concentration state detector 113 notifies the inhibiting unit 114 of such a state. In response to this notification, the inhibiting unit 114 changes (corrects) the notification setting information to a setting value that inhibits the window size of the window 252-2 from being changed or that decreases or minimizes the window size (non-display state), or that inhibits a message indicating the detection of an event from being displayed.

In operation D110, if the event detector 111 has detected an event in the television program displayed in the window 252-2, the notifying unit 112 notifies the user of the detection of an event on the basis of the notification setting information.

That is, if the inhibiting unit 114 has changed the notification setting information to inhibit the notifying unit 112 from notifying the user, the notification unit 112 notifies the user in a manner not to disturb the user, or controls the recorder 109 to record the television program in a background without notifying the user.

Then, the event detector 111 determines in operation D120 whether the display of the television program (television program data) has finished. If the display of the television program has not finished, the process returns to operation D60. If the display of the television program has finished, the process proceeds to operation D130. In operation D130 the changed notification setting information is stored. The processing is then completed.

As described above, according to the information processing apparatus 100, when the work concentration state detector 113 has detected that the user is in the work concentration state, the notifying unit 112 stops notifying the user of the generation of an event. This can improve the work efficiency without disturbing work on which the user is concentrating.

Accordingly, when the user leisurely watch a television program displayed in the window 252-2 while doing another work in the window 252-1 of the information processing apparatus 100, a determination as to whether to notify the user of the generation of an event is made in the following manner. If the user does not concentrate on work in the window 252-1, the notification unit 112 notifies the user of the generation of such an event. In contrast, if the user concentrates on work in the window 252-1, the notifying unit 112 does not notify the user of the generation of such an event, which prevents the user from being disturbed. That is, it can be precisely and suitably determine whether to notify the user of the generation of an event depending on whether the user concentrates on work.

The work concentration state detector 113 can determine whether the user is in the work concentration state on the basis of the screen area processing state information indicating the processing states of the plurality of windows 252 obtained by the state information acquisition unit 102. It is thus possible to easily detect the work concentration state that matches the actual working state in the information processing apparatus 100, thereby enhancing the usability.

The work concentration state detector 113 can also determine whether the user is in the work concentration state on the basis of the apparatus processing state information concerning the processing executed in the information processing apparatus 100 by the apparatus processing state information acquisition unit 108. It is thus possible to easily detect the work concentration state that matches the actual working state in the information processing apparatus, thereby enhancing the usability.

It is now assumed that the notifying unit 112 notifies the user of the generation of an event by enlarging the size of the window 252-2 on the display 25. In this case, the inhibiting unit 114 inhibits the notifying unit 112 from enlarging the size of the window 252-2 or controls the notifying unit 112 from decreasing the size of the window 252-2. With this configuration, the work efficiency can be enhanced without disturbing the work on which the user is concentrating by the enlarged window 252-2.

The inhibiting unit 114 can suppress the volume of sound accompanying the display of a television program. With this configuration, the work efficiency can be enhanced without disturbing the work on which the user is concentrating by sound.

The inhibiting unit 114 can also change the window 252-2 to the non-display state, and can control the recorder 109 to record the television program displayed in the window 252-2. With this configuration, the work efficiency can be enhanced without disturbing the work on which the user is concentrating, and also, the user does not have to miss the television program since the recorded content can be displayed later, thereby enhancing the usability.

### C. Others

Programs (including a preference data generating program, a television program display program, and a playback program) for implementing the functions of the display controller 101, the state information acquisition unit 102, the preference evaluation value calculator 104, the apparatus processing state information acquisition unit 108, the preference reference value calculator 105, the preference data generator 107, the content playback unit 106, the recorder 109, the operation history generator 110, the event detector 111, the notifying unit 112, the work concentration state detector 113, and the inhibiting unit 114 can be provided in the form of a computer-readable recording medium, such as a flexible disk, a compact disc (CD) (including CD-ROM, CD-R, and CD-RW), a DVD (including DVD-ROM, DVD-RAM, DVD-R, DVD+R, DVD-RW, and DVD+RW), a magnetic disk, an optical disc, or a magneto-optical disk. A computer then reads the programs from the recording medium and transfers them to a built-in storage device or an external storage device. Alternatively, the programs may be recorded in a storage device (recording medium), such as a magnetic disk, an optical disc, or a magneto-optical disk, and may be provided from the storage device to the computer via a communication path.

To implement the functions of the above-described elements, the programs stored in the built-in storage device (RAM 29 or ROM 30 in this embodiment) are executed by a microprocessor (CPU 10 in this embodiment) of the computer. In this case, the programs may be recorded in a recording medium and the computer may read the programs from the recording medium.

The concept of the computer is such that it includes hardware and an OS, and more specifically, hardware is operating under the control of the OS. If an OS is not necessary and an application program can solely operate the hardware, the hardware itself can constitute the computer. The hardware includes at least a microprocessor, such as a CPU, and is enabled to read computer programs recorded on a recording medium. In this embodiment, the information processing apparatus 100 functions as a computer.

In addition to a flexible disk, a CD, a DVD, a magnetic disk, or a magneto-optical disk, the recording media may include various computer-readable media, such as an integrated circuit (IC) card, a ROM cartridge, magnetic tape, a punch card, a built-in storage device (RAM, ROM, or memory) of a computer, an external storage device used with a computer, printed matter on which codes, such as bar codes, are printed.

The present invention is not restricted to the above-described embodiments, and various modifications can be made within the concept of the invention.

For example, in the foregoing embodiments, the content acquisition unit 26 is configured as a receiver that can receive content broadcast via broadcast waves through an antenna. Alternatively, it may be a network device (for example, a local area network (LAN) card) that can receive content distributed via the Internet, or a reader (DVD reader) that reads content recorded on various media, such as DVD. Various modifications can be made within the concept of the invention.

In the foregoing embodiments, as in the content acquisition unit 26, the content information acquisition unit 27 is configured as a receiver that can receive EPG broadcast via broadcast waves through an antenna. Alternatively, it may be a network device that can receive content information (ADAMS-EPG+, iEPG, etc.) distributed via the Internet. Various modifications can be made within the concept of the invention.

In the aforementioned embodiments, the content is a television program received by the television tuner 271 by way of example. However, the content may be various types of data broadcast or distributed via the Internet or moving pictures provided by various media, such as DVDs. Various modifications can be made within the concept of the invention.

The content playback unit 106 may be a moving-picture playback program or a media playback program in accordance with the type of content. Various modifications can be made within the concept of the invention.

In accordance with the disclosure of the embodiments of the invention, it is possible to carry out or manufacture the invention by those skilled in the art.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An information processing apparatus including a display unit to display content in a content display screen area, which is at least one of a plurality of screen areas, displayed in the display unit, the information processing apparatus comprising:
an event detector detecting generation of a predetermined event concerning a content;
a notifying unit configured to notify a user of the information processing apparatus upon detecting the predetermined event by the event detector;
a work concentration state detector determining whether the user is in a work concentration state; and
an inhibiting unit inhibiting the notifying unit from notifying the user of the detecting of the predetermined event upon determining the user is in the work concentration state.

2. The information processing apparatus according to claim 1, wherein the work concentration state detector determines whether the user is in the work concentration state based on screen area processing state information concerning processing states of the plurality of screen areas.

3. The information processing apparatus according to claim 1, wherein the work concentration state detector determines whether the user is in the work concentration state based on apparatus processing state information concerning processing executed using the information processing apparatus.

4. The information processing apparatus according to claim 1, wherein the notifying unit is configured to notify the user of the detection of the predetermined event by enlarging a size of the content display screen area of the display unit, and the inhibiting unit inhibits the notifying unit from enlarging the size of the content display screen area.

5. The information processing apparatus according to claim 4, wherein the inhibiting unit inhibits the notifying unit by reducing the size of the content display screen area.

6. The information processing apparatus according to claim 1, wherein the inhibiting unit inhibits the notifying unit by decreasing a volume of sound accompanying the display of the content.

7. The information processing apparatus according to claim 1, further comprising:
a recorder for recording the content,
wherein the notifying unit is configured to notify the user of the detection of the predetermined event by enlarging the size of the content display screen area, the inhibiting unit changes the content display screen area to a non-display state, and the recorder records the content.

8. A display method for displaying content in a content display screen area, which is at least one of a plurality of screen areas, displayed in a display unit of an information processing apparatus, the display method comprising:
detecting generation of a predetermined event concerning a content;
notifying a user of the information processing apparatus of the detection of the predetermined event upon detecting the predetermined event;
determining whether the user is in a work concentration state; and
inhibiting the user from being notified of the detecting of the predetermined event upon determining that the user is in the work concentration state.

9. The display method according to claim 8, wherein the work concentration state of the user is determined based on screen area processing state information concerning processing states of the plurality of screen areas of the information processing apparatus.

10. The display method according to claim 8, wherein the work concentration state of the user is determined whether based on apparatus processing state information concerning processing executed in the information processing apparatus.

11. The display method according to claim 8, wherein the notifying of the detection of the predetermined event is enabled by enlarging a size of the content display screen area of the display unit, and the size of the content display screen area is inhibited from being enlarged based on the inhibiting.

12. The display method according to claim 11, wherein the sizes of the content display screen area is reduced based on the inhibiting.

13. The display method according to claim 8, wherein a volume of a sound accompanying the display of the content is decreased based on the inhibiting.

14. The display method according to claim 8, further comprising:
recording the content,
wherein the notifying of the user of the detection of the predetermined event is enabled by enlarging the size of the content display screen area, the content display screen area is changed to a non-display state based on the inhibiting, and the content is recorded based on the recording.

15. A computer-readable recording medium recording thereon a display program allowing a computer to execute operations including displaying content in a content display screen area, which is at least one of a plurality of screen areas, displayed in a display unit of an information processing apparatus, the operations comprising:
detecting generation of a predetermined event concerning a content;
notifying a user of the information processing apparatus upon detecting the predetermined event;
determining whether the user is in a work concentration state; and
inhibiting the user from being notified of the detecting of the predetermined event upon determining that the user is in the work concentration state.

16. The computer-readable recording medium according to claim 15, wherein the work concentration state of the user is determined based on screen area processing state information concerning processing states of the plurality of screen areas of the information processing apparatus.

17. The computer-readable recording medium according to claim 15, wherein the work concentration state of the user is determined based on apparatus processing state information concerning processing executed in the information processing apparatus.
